(19) United States
(12) Patent Application Publication
(10) Pub. No.: US 2026/0356244 A1
(43) Pub. Date: Nov. 12, 2026

(54) CHARGING CONTROL APPARATUS FOR VEHICLE

(71) Applicant: SUBARU CORPORATION, Tokyo (JP)

(72) Inventors: Takahiro KINOSHITA, Tokyo (JP); Junpei TSUCHIYA, Tokyo (JP)

(21) Appl. No.: 19/716,932

(22) Filed: Jun. 23, 2026

Related U.S. Application Data
(63) Continuation of application No. PCT/JP2024/005047, filed on Feb. 14, 2024.

(51) Int. Cl. B60L 58/20; H02J 7/34

(52) U.S. Cl. CPC B60L 58/20; H02J 7/342; B60L 2240/12

(57) ABSTRACT

A charging control apparatus for a vehicle is configured to: supply electric power of a traveling battery to an auxiliary battery and reduce a deviation between a remaining charge amount and a control target value upon a ready ON state; supply the electric power until the remaining charge amount reaches an upper limit threshold upon a transition to a ready OFF state, in which the upper limit threshold is higher than the control target value and lower than a value corresponding to a fully-charged state; and start charging of the auxiliary battery when the remaining charge amount becomes less than a lower limit threshold in the ready OFF state. The lower limit threshold is lower than the control target value and prevents difficulty in starting a vehicle system. The remaining charge amount takes a value between the upper limit threshold and the lower limit threshold upon the ready ON state.

### CROSS-REFERENCE TO RELATED APPLICATIONS

This application is continuation of International Application No. PCT/JP2024/005047, filed on Feb. 14, 2024, the entire content of which are hereby incorporated by reference.

### BACKGROUND

The disclosure relates to a charging control apparatus for a vehicle which controls charging of an in-vehicle battery mounted on the vehicle.

Electric vehicles able to travel without using fuel such as gasoline have become popular. Such an electric vehicle includes, in addition to an auxiliary battery, a large-capacity traveling battery to be used for traveling of the vehicle.

The auxiliary battery is used for starting of a system of the vehicle. Accordingly, the vehicle can suffer from difficulties in starting and traveling accordingly, when a remaining charge amount of the auxiliary battery is excessively reduced in a ready OFF state of the vehicle.

Japanese Unexamined Patent Application Publication No. 2006-174619 discloses a technique in which charging of the auxiliary battery is performed with a remaining charge amount of the traveling battery, when the remaining charge amount of the auxiliary battery is decreased. This prevents the excessive decrease in the remaining charge amount of the auxiliary battery in the ready OFF state of the vehicle, and avoids a non-travelable state of the vehicle.

### SUMMARY

An aspect of the disclosure provides a charging control apparatus for a vehicle. The charging control apparatus includes one or more processors and a storage medium. The storage medium is configured to store a program to be executed by the one or more processors. The program includes one or more commands. The one or more commands are configured to cause the one or more processors to: supply electric power to be supplied from a traveling battery of the vehicle to an auxiliary battery of the vehicle and reduce a deviation between a remaining charge amount of the auxiliary battery and a control target value, upon a ready ON state of the vehicle in which the vehicle is able to perform traveling, in which the auxiliary battery is a lithium-ion battery; supply the electric power to be supplied from the traveling battery to the auxiliary battery until the remaining charge amount of the auxiliary battery reaches an upper limit threshold, upon a transition of the vehicle from the ready ON state to a ready OFF state in which the vehicle involves difficulty in the traveling, in which the upper limit threshold is a value higher than the control target value and lower than a value that corresponds to a fully-charged state of the auxiliary battery; and start charging of the auxiliary battery with the electric power to be supplied from the traveling battery, when the remaining charge amount of the auxiliary battery becomes less than a lower limit threshold in the ready OFF state, in which the lower limit threshold is a value that is lower than the control target value and that is configured to prevent a system of the vehicle from becoming difficult to start. The remaining charge amount of the auxiliary battery is configured to be controlled to take a value between the upper limit threshold and the lower limit threshold upon the ready ON state.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a configuration example of a vehicle mounted with a charging control apparatus for a vehicle according to one example embodiment of the disclosure.

FIG. 2 is a block diagram illustrating a configuration example of a controller illustrated in FIG. 1.

FIG. 3 is a block diagram illustrating a configuration example of a central ECU illustrated in FIG. 1.

FIG. 4 is a diagram illustrating an example of charging control corresponding to an elapse of time.

FIG. 5 is a flowchart illustrating an example of a process to be executed by the central ECU.

### DETAILED DESCRIPTION

Each component related to charging is to be activated when charging an auxiliary battery with a vehicle being in a ready OFF state. When the number of times of charging of the auxiliary battery increases, the number of times of activation of each component also increases, which can accelerate a deterioration of each electronic component to which a high voltage is applied.

It is desirable to provide a charging control apparatus for a vehicle which makes it possible to avoid a non-travelable state of a vehicle and suppress a deterioration of each component related to charging.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Configuration of Vehicle

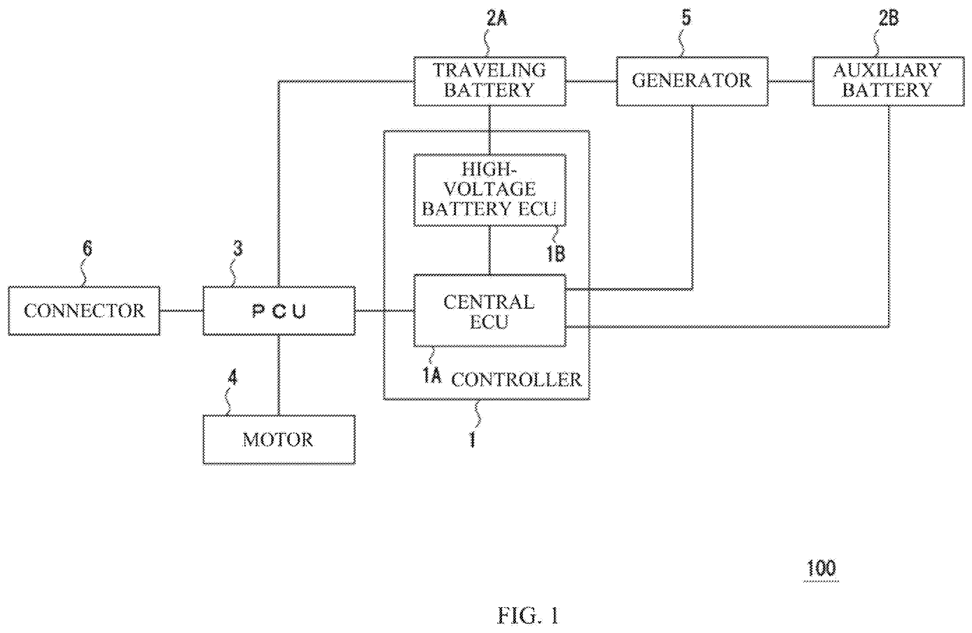

FIG. 1 illustrates a configuration example of a vehicle 100 mounted with a charging control apparatus according to an example embodiment of the disclosure.

The vehicle 100 may include a controller 1, an in-vehicle battery 2, a power control unit (PCU) 3, a motor 4, a generator 5, and a connector 6.

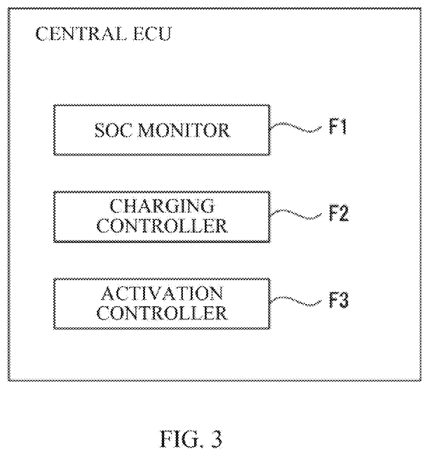

Note that FIG. 3 illustrates some configurations mounted on the vehicle 100. The vehicle 100 may include, as appropriate, non-illustrated devices including, for example, a map locator, various sensors for driving of the vehicle 100, and a communication device.

The controller 1 may perform an overall control of the vehicle 100. The controller 1 may be provided as a single unit, or may be configured by multiple electronic control units (ECUs). Non-limiting examples of the ECUs may include: a central ECU 1A that comprehensively manages and controls the vehicle 100; a high-voltage battery ECU 1B that performs a control such as a charging control of a high-voltage battery; a display control ECU that performs a display control of a display device included in the vehicle 100; an airbag control ECU, and an air-conditioning control ECU. The display device may include a device such as a meter.

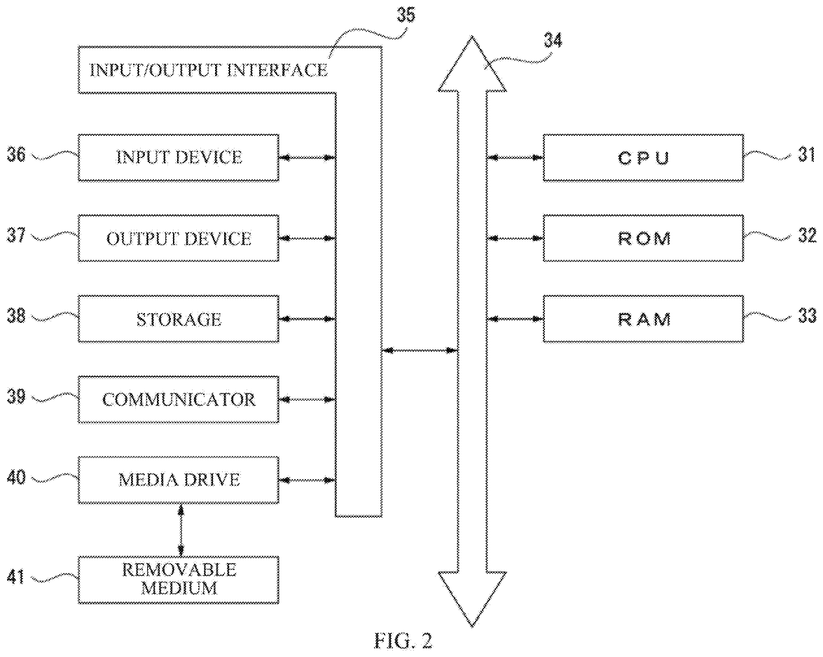

Referring to FIG. 2, the controller 1 or one or more of various ECUs described above may have devices including, for example: a central processing unit (CPU) 31; a read-only memory (ROM) 32; a random-access memory (RAM) 33; a bus 34; an input/output interface 35; an input device 36; an output device 37; a storage 38; a communicator 39; and a media drive 40. Note that a part of the devices may be selectively provided for each of the ECUs as appropriate. For example, not all the ECUs may not be provided with all the configurations illustrated in FIG. 2.

The CPU 31 may execute various processes in accordance with a program stored in the ROM 32 or a program loaded from the storage 38 into the RAM 33. The RAM 33 may also hold data and the like used to be for the CPU 31 to execute various processes.

The CPU 31, the ROM 32, and the RAM 33 may be coupled to each other via the bus 34. The input/output interface 35 may also be coupled to the bus 34.

The input/output interface 35 may be coupled to the input device 36, the output device 37, the storage 38, the communicator 39, and the media drive 40.

The input device 36 may receive signals from various sensors coupled to a device such as the controller 1.

The output device 37 may output control data for a device such as an actuator coupled to the ECU. The actuators may drive respective components of the vehicle 100. The output device 37 may be a display or a speaker to notify a user of various pieces of information. The display may be any display such as a liquid crystal display (LCD) or an organic electroluminescence (EL) display.

The storage 38 may be any storage device such as a hard disk drive (HDD) or a flash memory device.

The communicator 39 may perform a communication process that performs a communication with any other ECU. The communication may be performed via a controller area network (CAN). The communicator 39 may be designed to communicate with an external device such as a server via a communication network outside the vehicle 100.

The media drive 40 may be mounted as necessary with a removable medium 41. Non-limiting examples of the removable medium 41 may include a semiconductor memory, a magnetic disk, an optical disk, and a magneto-optical disk. The media drive 40 may write and read data to and from the removable medium 41.

The central ECU 1A may be a controller that achieves various processes and operations by cooperating with various ECUs and components. For example, the central ECU 1A, gives display instructions to the display control ECU at an appropriate timing to provide a desired displaying to an occupant. The central ECU 1A may cooperate with the airbag control ECU to activate the airbag and improve the safety of the occupant accordingly, when a predetermined condition is satisfied.

The controller 1 may perform an operation such as controlling charging of the in-vehicle battery 2 mounted on the vehicle 100 or managing a remaining charge amount (SOC: State Of Charge) of the in-vehicle battery 2.

The vehicle 100 may include multiple batteries as the in-vehicle battery 2. For example, the vehicle 100 includes a traveling battery 2A and an auxiliary battery 2B. The traveling battery 2A may be the in-vehicle battery 2 that is higher in voltage as compared with the auxiliary battery 2B.

The traveling battery 2A may be a high-voltage battery of several hundred volts to be used for traveling of the vehicle 100. The traveling battery 2A may supply electric power to be used for driving of wheels and electric power to be used for an operation of an air conditioner of the vehicle 100. FIG. 1 illustrates a supply of electric power to be used for driving of the wheels from the traveling battery 2A. Note that the illustration of a supply of electric power to be used for operations of the other components are omitted in FIG. 1.

The high-voltage battery ECU 1B may manage, for example, the traveling battery 2A that is relatively high in voltage out of the in-vehicle batteries 2.

The high-voltage battery ECU 1B may be coupled to sensors to be used for managing of the traveling battery 2A. The high-voltage battery ECU 1B may perform operations including, for example, charging and discharging and a temperature control of the traveling battery 2A, based on detected values obtained from the sensors. Non-limiting examples of the sensor may include a voltage sensor, a current sensor, and a temperature sensor.

The traveling battery 2A may be charged based on a DC voltage supplied from the PCU 3. The traveling battery 2A may provide, to the PCU 3, a power supply voltage for driving of the motor 4.

The PCU 3 may include devices including, for example, an inverter and a DC/DC converter for driving of the motor 4.

The PCU 3 may generate an AC current to be used for driving of the motor 4, based on the supplied power supply voltage, and supply the AC current to the motor 4. The PCU 3 may control a torque of the motor 4 by controlling the AC current. The PCU 3 may optimize an energy efficiency that utilizes a regenerative energy by performing a control that causes the motor 4 to perform a regenerative braking.

The motor 4 may be configured as a motor generator that generates electric power, and drive the wheels based on the supplied AC current.

The connector 6 may have a structure in which a charging plug included in charging equipment provided in each home or stand is insertable. The connector 6 may output, to the PCU 3, an AC voltage supplied through the inserted charging plug. The PCU 3 may charge the traveling battery 2A by supplying, to the traveling battery 2A, a DC voltage converted by an AC/DC converter included in the PCU 3.

In some embodiments, the auxiliary battery 2B may be a lithium-ion battery. The lithium-ion battery may have an example voltage of 12 volts. The auxiliary battery 2B may supply driving electric power to various auxiliary machines mounted on the vehicle 100. Non-limiting examples of the auxiliary machine may include various lights, a navigation system, audio equipment, and wipers.

The central ECU 1A may manage, for example, the auxiliary battery 2B that is relatively low in voltage out of the in-vehicle batteries 2.

The central ECU 1A according to an example embodiment may receive data on the SOC from the auxiliary battery 2B, and perform a charging control of the auxiliary battery 2B by activating each component, when the SOC falls below a threshold. The generator 5 may be used to charge the auxiliary battery 2B.

The generator 5 may include a device such as a DC/DC converter. The generator 5 may charge the auxiliary battery 2B by stepping down the high-voltage electric power supplied from the traveling battery 2A and supplying the thus-lowered electric power to the auxiliary battery 2B. For example, the generator 5 may charge the auxiliary battery 2B, based on instructions received from the central ECU 1A.

### 2. Configuration of Central ECU 1A

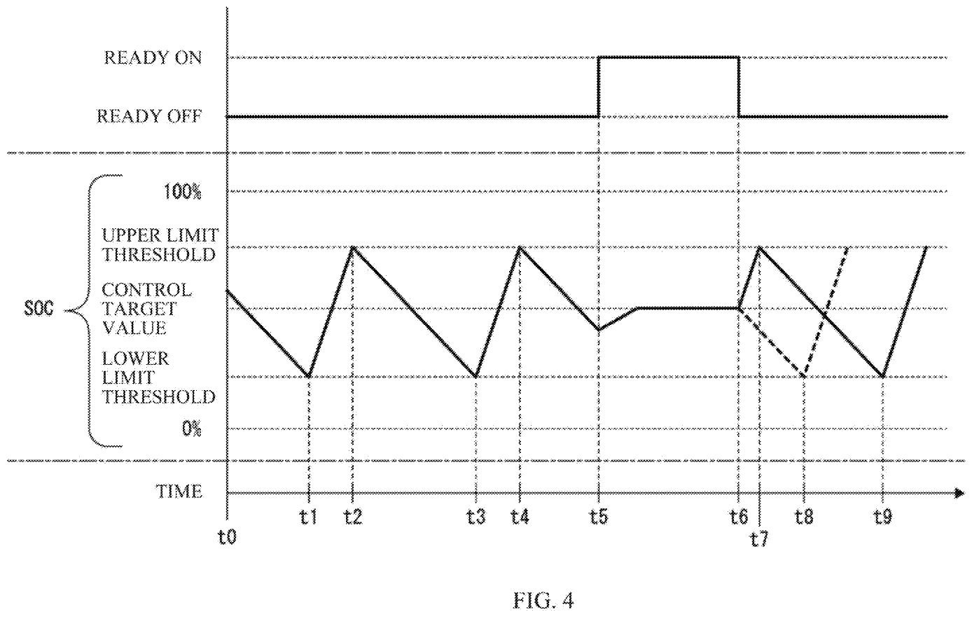

FIG. 4 illustrates an example of a configuration of the central ECU 1A.

The central ECU 1A may include a SOC monitor F1, a charging controller F2, and an activation controller F3.

The SOC monitor F1 may receive data on the SOC from the auxiliary battery 2B and manage the SOC. The SOC monitor F1 may supply the SOC of the auxiliary battery 2B to the charging controller F2.

The charging controller F2 may start or stop the charging of the auxiliary battery 2B, based on the SOC of the auxiliary battery 2B received from the SOC monitor F1. In some embodiments, the charging of the auxiliary battery 2B by the charging controller F2 may be performed in a ready ON state in which a powertrain is activated and the vehicle 100 is allowed to travel. In addition, the charging of the auxiliary battery 2B by the charging controller F2 may be performed also in a ready OFF state.

In the ready ON state, the charging controller F2 may perform a charging control that causes the remaining charge amount (SOC) of the auxiliary battery 2B reaches a control target value Ctv.

The charging controller F2 may instruct the activation controller F3 to activate each component, when the charging of the auxiliary battery 2B is to be started in the ready OFF state.

The activation controller F3 may activate the high-voltage battery ECU 1B, based on instructions received from the charging controller F2. The activation controller F3 may activate the traveling battery 2A via the high-voltage battery ECU 1B, based on instructions received from the charging controller F2. The activation controller F3 may also activate the generator 5.

The charging controller F2 may perform a charging control of the auxiliary battery 2B with an appropriate voltage, in response to the activation controller F3 activating each component. The appropriate voltage may be obtained by stepping down the high voltage supplied from the traveling battery 2A by the generator 5.

The charging controller F2 may stop the charging of the auxiliary battery 2B by the traveling battery 2A, when the remaining charge amount of the auxiliary battery 2B becomes equal to or greater than a threshold.

### 3. Example of Charging Control

FIG. 4 illustrates an example of the charging control to be performed by the central ECU 1A. Note that FIG. 4 illustrates a change in the SOC of the auxiliary battery 2B and a change in an activation state of the powertrain, in response to an elapse of time. For example, FIG. 4 illustrates a state in which the vehicle 100 is in the ready OFF state to the ready ON state in which the vehicle 100 is traveling, and the vehicle 100 is thereafter parked and changed to the ready OFF state again accordingly, in response to the elapse of time. In some embodiments, the ready OFF state may include a state where the vehicle 100 is parked.

A period from a timing t0 to a timing t1 may be a non-charging period in which the auxiliary battery 2B is not charged. A period from the timing t1 at which the SOC of the auxiliary battery 2B reaches a lower limit threshold Th1 to a timing t2 may be a charging period in which the charging of the auxiliary battery 2B is performed.

In some embodiments, the lower threshold Th1 may be a value that is lower than the control target value Ctv and that is configured to prevent a system of the vehicle 100 from becoming difficult to start up. In some embodiments, the lower limit threshold Th1 may be 30%. In such embodiments, the charging control by the charging controller F2 may be started when the SOC of the auxiliary battery 2B decreases to 30%.

This configuration helps to prevent the vehicle 100 from becoming difficult to travel due to the excessive decrease in the SOC of the auxiliary battery 2B and the difficulty in the restart of the vehicle 100 accordingly.

The timing t2 may be a timing at which the SOC of the auxiliary battery 2B reaches an upper limit threshold Th2. The charging of the auxiliary battery 2B may be continued until the SOC reaches the upper limit threshold Th2.

In some embodiments, the upper limit threshold Th2 may be a value that is higher than the control target value Ctv and that is lower than a value (such as 100%) corresponding to a fully-charged state of the auxiliary battery 2B.

In some embodiments, the upper limit threshold Th2 may be 60%. In such embodiments, the charging by the traveling battery 2A may be stopped by the charging controller F2 when the SOC of the auxiliary battery 2B increases to 60%.

A period from a timing t2 at which the SOC reaches the upper limit threshold Th2 to a timing t3 at which the SOC decreases to the lower limit threshold Th1 may be set as the non-charging period.

A period from the timing t3 to the timing t4 may be set again as the charging period.

In an example embodiment illustrated in FIG. 4, the vehicle 100 starts traveling in the non-charging period that starts from the timing t4.

At a timing t5, the charging controller F2 may control the SOC to the control target value Ctv that is different from the lower limit threshold Th1 and the upper limit threshold Th2, in response to an starting operation of a startup button or a starting operation of a key at the timing t5. For example, the charging of the auxiliary battery 2B may be stopped when the SOC of the auxiliary battery is higher than the control target value Ctv. The charging may be started when the SOC becomes lower than the control target value Ctv by a certain amount or more, as the electric power is supplied from the auxiliary battery 2B to the auxiliary machine.

Note that managing the SOC during the traveling of the vehicle 100 based on an intermediate SOC helps to delay the deterioration of the auxiliary battery 2B, in some embodiments where the auxiliary battery 2B is a lithium-ion battery. In some embodiments, the control target value Ctv may be larger than the lower limit threshold Th1 and smaller than the upper limit threshold Th2.

For example, the control target value Ctv may be set to 50% when the lower limit threshold Th1 is set to 30% and the upper limit threshold Th2 is set to 60%.

The charging control may be so performed that the SOC of the auxiliary battery 2B is maintained around the control target value Ctv while the vehicle 100 is in the ready ON state, e.g., in a period from the timing t5 to a timing t6.

At the timing t6, the charging of the auxiliary battery 2B is not stopped immediately after the vehicle 100 is brought into the ready OFF state, but the charging of the auxiliary battery 2B is stopped after the charging is continued until the upper limit threshold Th2 is satisfied. For example, a period from the timing t6 to a timing t7 may be set as the charge period of the auxiliary battery 2B.

This configuration helps to keep the SOC of the auxiliary battery 2B higher than the lower limit threshold Th1 until a timing t9. The timing t9 may be after a timing t8 at which the remaining charge amount decreases to the lower limit threshold Th1 when the charging of the auxiliary battery 2B is stopped immediately after the ready OFF state is satisfied.

The charging period of the auxiliary battery 2B from the timing t6 to the timing t7 may be a period in which the charging is performed following the charging control where the vehicle 100 is traveling, and each component used for the charging of the auxiliary battery 2B remains activated. Accordingly, the charging period from the timing t6 to the timing t7 may eliminate the necessity of the activation control of each component related to the charging, and eliminate switching of a high-voltage relay as well.

A charging period of the auxiliary battery 2B starting from the timing t9 may be a period during which the vehicle 100 is in the ready OFF state and starting from a state in which each component to be used for the charging of the auxiliary battery 2B is not activated. For example, the high-voltage battery ECU 1B, the traveling battery 2A, and the generator 5 are to be started for the charging of the auxiliary battery 2B. In addition, the switching of the high-voltage relay is to be performed.

The activation of the traveling battery 2A can promote a deterioration of an electronic component such as a high-voltage relay or a capacitor included in the traveling battery 2A. Accordingly, the number of times of the activation of the traveling battery 2A is to be reduced.

As illustrated in FIG. 4, extending the time from a timing at which the vehicle 100 is placed into the ready OFF state to a timing at which the SOC of the auxiliary battery 2B decreases to the lower limit threshold Th1 helps to reduce the number of times of the activation of the component such as the traveling battery 2A, and to extend the lifespan of each component.

### 4. Example of Process

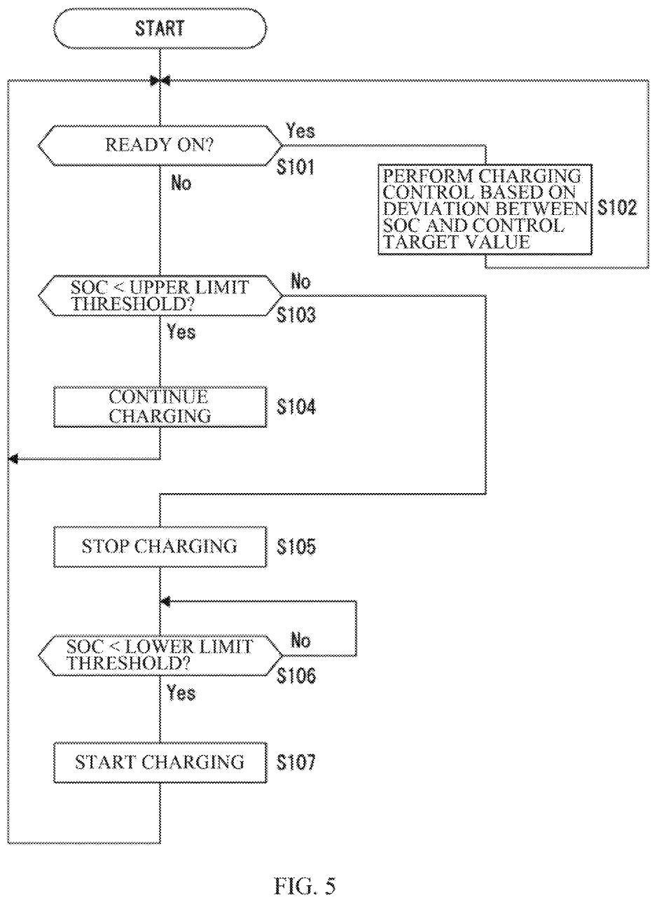

FIG. 5 illustrates an example of a process to be executed by the central ECU 1A.

In step S101, the central ECU 1A may determine whether the vehicle 100 is in the ready ON state. If the central ECU 1A determines that the vehicle 100 is in the ready ON state (step S101: Yes), the central ECU 1A may cause the process to proceed to step S102. In step S102, the central ECU 1A may perform the charging control of the auxiliary battery 2B to cause the SOC of the auxiliary battery 2B to be or close to the control target value Ctv.

After the process of step S102 is completed, the central ECU 1A may execute the process of step S101 again.

For example, while the vehicle 100 is in the ready ON state, the central ECU 1A may perform the charging control of the auxiliary battery 2B to cause the SOC of the auxiliary battery 2B not to deviate from the control target value Ctv while detecting a change in state of the vehicle 100 to the ready OFF state.

If the ready OFF state is detected in step S101 (step S101: No), for example, if the vehicle 100 shifts to a parking state, the central ECU 1A may cause the process to proceed to step S103. In step S103, the central CPU 1A may compare SOC of the auxiliary battery 2B with the upper limit threshold Th2, and perform a branching process based on a result of the comparison.

For example, in step S103, if the central ECU 1A determines that the SOC of the auxiliary battery 2B is less than the upper limit threshold Th2 (step S103: Yes), the central ECU 1A may continue the charging of the auxiliary battery 2B and increase the SOC. The central ECU 1A may perform a branching process of step S103 again after step S104.

In other words, the central ECU 1A may continue to perform the charging until the SOC of the auxiliary battery 2B reaches the upper limit threshold Th2, even immediately after the vehicle 100 enters the ready OFF state from the ready ON state (step S103 and step S104).

Thereafter, if the central ECU 1A determines that the SOC of the auxiliary battery 2B has reached the upper limit threshold Th2 by the charging control continued even after the vehicle 100 has entered the ready OFF state (step S103: No), the central ECU 1A may cause the process to proceed to step S105 and stop the charging of the auxiliary battery 2B.

Thereafter, the central ECU 1A may compare the SOC of the auxiliary battery 2B with the lower limit threshold Th1 in step S106, and perform a branching process based on a result of the comparison.

For example, if the central ECU 1A determines that the SOC of the auxiliary battery 2B is not less than the lower limit threshold Th1 (step S106: No), the central ECU 1A may repeatedly execute step S106 to continue a state in which the charging is stopped until the SOC of the auxiliary battery 2B becomes less than the lower limit threshold Th1.

Thereafter, in step S106, if the central ECU 1A determines that the SOC of the auxiliary battery 2B is less than the lower limit threshold Th1 (step S106: Yes), the central ECU 1A may cause the process to proceed to step S107 and start the charging of the auxiliary battery 2B. Note that, at this time, the central ECU 1A may activate each component to charge the auxiliary battery 2B with the traveling battery 2A as described above.

After completing the process of step S107, the central ECU 1A may return the process to step S101 and determine whether the vehicle 100 has entered the ready ON state. Until the vehicle 100 enters the ready ON state, the processes from step S103 to step S107 may be repeatedly executed, whereby the charging period and the non-charging period are repeated, such as the period from the timing t0 to the timing t5 or the period after the timing t7 illustrated in FIG. 4.

### 5. Conclusion

The vehicle 100 includes the controller 1. In one embodiment, the controller 1 may serve as a “charging control apparatus for a vehicle”. For example, the vehicle 100 includes the central ECU 1A and the high-voltage battery ECU 1B.

The controller 1 includes one or more processors and a storage medium that contains a program to be executed by the one or more processors. In some embodiments, the one or more processors may be the CPU 31. In some embodiments, the storage medium may be the ROM 32, the RAM 33, or the storage 38. The program includes one or more commands, and the one or more commands cause the one or more processors to execute at least the following two processes.

One of the processes is: a process (e.g. step S102) that supplies, to the auxiliary battery 2B, the electric power to be supplied from the traveling battery 2A to cause a deviation between the remaining charge amount (e.g., the SOC) of the auxiliary battery 2B and the control target value Ctv to be reduced or eliminated in the ready ON state in which the vehicle 100 is able to travel. Another one of the processes is: a process (e.g., step S103 and step S104) that supplies, to the auxiliary battery 2B, the electric power to be supplied from the traveling battery 2A until the remaining charge amount of the auxiliary battery 2B reaches the upper limit threshold Th2, upon a transition from the ready ON state to the ready OFF state in which the vehicle 100 becomes difficult to travel.

The upper limit threshold Th2 is a value higher than the control target value Ctv.

This configuration helps to allow the vehicle 100 to enter the parking state with more electric power being charged in the auxiliary battery 2B than the electric power charged in the auxiliary battery 2B by the management of the SOC during traveling of the vehicle 100, when the vehicle 100 has made the transition from the ready ON state to the ready OFF state.

Accordingly, this configuration helps to extend a period of time until the electric power charged in the auxiliary battery 2B is exhausted in the parking state, and to prevent the vehicle 100 from falling into the non-traveling state due to an insufficient remaining charge amount of the auxiliary battery 2B.

In some embodiments where the auxiliary battery 2B is the in-vehicle battery 2 that allows for extension of lifespan by being used based on the intermediate SOC, such as the lithium-ion battery, setting the control target value Ctv to a value lower than the upper limit threshold Th2 helps to extend the time in which the auxiliary battery 2B is used based on the intermediate SOC, which in turn helps to make the lifespan of the auxiliary battery 2B longer.

In the above-described configuration, the generator 5 used upon charging the auxiliary battery 2B with the electric power of the traveling battery 2A may be provided outside the PCU 3. In some embodiments, the generator 5 may be provided inside the PCU 3.

In some embodiments, in the controller 1 that serves as the charging control apparatus for the vehicle in one embodiment of the disclosure, such as the central ECU 1A or the high-voltage battery ECU 1B, the one or more commands may cause the one or more processors such as the CPU 31 to execute a process (e.g., step S107) that supplies, to the auxiliary battery 2B, the electric power to be supplied from the traveling battery 2A, when the remaining charge amount (e.g., SOC) of the auxiliary battery 2B becomes less than the lower limit threshold Th1 in the ready OFF state of the vehicle 100. In some embodiments, the lower limit threshold Th1 may be a value lower than the control target value Ctv.

Charging the auxiliary battery 2B with the electric power of the traveling battery 2A when the SOC of the auxiliary battery 2B becomes less than the lower limit threshold Th1 in the ready OFF state of the vehicle 100 helps to prevent the vehicle 100 from falling into the non-traveling state due to the insufficient remaining charge amount of the auxiliary battery 2B even in the ready OFF state.

In some embodiments, the control target value Ctv may be a value higher than the lower limit threshold Th1. In some embodiments, the control target value Ctv may be a value between the lower limit threshold Th1 and the upper limit threshold Th2. This configuration allows the auxiliary battery 2B to be managed based on a more intermediate SOC upon traveling of the vehicle 100, which helps to suppress the deterioration of the auxiliary battery 2B and to extend the lifespan of the auxiliary battery 2B.

In some embodiments, the auxiliary battery 2B may be the lithium-ion battery. Adopting, as the auxiliary battery 2B, the lithium-ion battery in which the deterioration is suppressed by the management of the SOC based on the intermediate SOC as compared with a lead-acid battery helps to suitably achieve one or more example effects described above.

The charging control apparatus for the vehicle according to at least one embodiment of the disclosure helps to avoid the non-travelable state of the vehicle 100 and suppress the deterioration of each component related to the charging.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The controller 1 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the controller 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the controller 1 illustrated in FIG. 1.

1. A charging control apparatus for a vehicle, the charging control apparatus comprising:
one or more processors; and
a storage medium configured to store a program to be executed by the one or more processors,
the program comprising one or more commands, the one or more commands being configured to cause the one or more processors to
supply electric power to be supplied from a traveling battery of the vehicle to an auxiliary battery of the vehicle and reduce a deviation between a remaining charge amount of the auxiliary battery and a control target value, upon a ready ON state of the vehicle in which the vehicle is able to perform traveling, the auxiliary battery comprising a lithium-ion battery,
supply the electric power to be supplied from the traveling battery to the auxiliary battery until the remaining charge amount of the auxiliary battery reaches an upper limit threshold, upon a transition of the vehicle from the ready ON state to a ready OFF state in which the vehicle involves difficulty in the traveling, the upper limit threshold comprising a value higher than the control target value and lower than a value that corresponds to a fully-charged state of the auxiliary battery, and
start charging of the auxiliary battery with the electric power to be supplied from the traveling battery, when the remaining charge amount of the auxiliary battery becomes less than a lower limit threshold in the ready OFF state, the lower limit threshold comprising a value that is lower than the control target value and that is configured to prevent a system of the vehicle from becoming difficult to start, the remaining charge amount of the auxiliary battery being configured to be controlled to take a value between the upper limit threshold and the lower limit threshold upon the ready ON state.

2. The charging control apparatus for the vehicle according to claim 1, wherein
the ready ON state comprises a state in which a powertrain of the vehicle is activated, and the ready OFF state comprises a state in which the vehicle is parked.
